(19) United States
(12) Patent Application Publication
(10) Pub. No.: US 2012/0213098 A1
(43) Pub. Date: Aug. 23, 2012

(54) Real-time and synchronization Internet of things analyzer System Architecture

(75) Inventor: JULAN SUN, Plainsboro, NJ (US)

(73) Assignee: Future Wireless Tech LLC, Plainsboro, NJ (US)

(21) Appl. No.: 13/031,595

(22) Filed: Feb. 21, 2011

(51) Int. Cl. H04L 12/26; H04W 74/02

(52) U.S. Cl. 370/252; 370/338

(57) ABSTRACT

The Internet of things needs using the self-configuring wireless sensors network to interconnect all things.

Using a internet of things analyzer Architecture and methods, we can real time monitor and analysis the wireless network nodes, routing, coordinator to collect the information of the spectrum, the noise, the network of communication protocol, the EPC RFID data communication protocol and the states, low power states . . . .

The architecture and methods will help build the high reliability, long battery life, green Internet of things and wireless sensors network.

### BACKGROUND OF THE INVENTION

1. Field of the Invention

The present invention relates to Internet of things and wireless sensor net work.

2. Description of the Related Art

The Internet of things, also known as the Internet of objects, refers to the networked interconnection of everyday objects It is described as a self-configuring wireless network of sensors whose purpose would be to interconnect all things. The concept is attributed to the former Auto-ID Center, founded in 1999, based at the time at the Massachusetts Institute of Technology (MIT);

ZigBee is a low-cost, low-power, wireless mesh networking standard. First, the low cost allows the technology to be widely deployed in wireless control and monitoring applications. Second, the low power-usage allows longer life with smaller batteries. Third, the mesh networking provides high reliability and more extensive range. There are three different types of ZigBee devices: ZigBee coordinator (ZC), ZigBee Router (ZR), ZigBee End Device (ZED): Zigbee net allows the ZED node to be asleep a significant amount of the time thereby giving long battery life. ZigBee devices are required to conform to the IEEE 802.15.4-2003 Low-Rate Wireless Personal Area Network (WPAN) standard. The standard specifies the lower protocol layers—the physical layer (PHY), and the media access control (MAC) portion of the data link layer (DLL). This standard specifies operation in the unlicensed 2.4 GHz (worldwide), 915 MHz (Americas) and 868 MHz (Europe) ISM bands. In the 2.4 GHz band there are 16 ZigBee channels, with each channel requiring 5 MHz of bandwidth. The center frequency for each channel can be calculated as, F_{C}=(2405+5*(ch−11)) MHz, where ch=11, 12, . . . , 26; Zigbee protocols build on recent algorithmic research (Ad-hoc On-demand Distance Vector) to automatically construct a low-speed ad-hoc network of nodes. In most large network instances, the network will be a cluster of clusters. It can also form a mesh or a single cluster. The current profiles derived from the ZigBee protocols support beacon and non-beacon enabled networks.

6lowpan is an acronym of IPv6 over Low power Wireless Personal Area Networks, or (as the “personal” qualification is no longer relevant), IPv6 over LoW Power wireless Area Networks. 6lowpan is the name of a working group in the internet area of the IETF. The 6lowpan group has defined encapsulation and header compression mechanisms that allow IPv6 packets to be sent to and received from over IEEE 802.15.4 based networks. IPv4 and IPv6 are the work horses for data delivery for local-area networks, metropolitan area networks, and wide-area networks such as the Internet. Likewise, IEEE 802.15.4 devices provide sensing communication-ability in the wireless domain. The inherent natures of the two networks though, are different.

Bluetooth is a proprietary open wireless technology standard for exchanging data over short distances (using short wavelength radio transmissions) from fixed and mobile devices, creating personal area networks (PANs) with high levels of security. Created by telecoms vendor Ericsson in 1994; Bluetooth uses a radio technology called frequency-hopping spread spectrum, which chops up the data being sent and transmits chunks of it on up to 79 bands (1 MHz each) in the range 2402-2480 MHz. This range is in the globally unlicensed Industrial, Scientific and Medical (ISM) 2.4 GHz short-range radio frequency band. Bluetooth is defined as a layer protocol architecture consisting of core protocols, cable replacement protocols, telephony control protocols, and adopted protocols. Mandatory protocols for all Bluetooth stacks are: LMP, L2CAP and SDP. Additionally, these protocols are almost universally supported: HCI and RFCOMM; Bluetooth low energy is an alternative to the Bluetooth standard that was introduced in Bluetooth v4.0, and is aimed at very low power applications running off a coin cell. It allows two types of implementation, dual-mode and single-mode. In a dual-mode implementation, Bluetooth low energy functionality is integrated into an existing Classic Bluetooth controller.

DASH7 is a new wireless sensor networking technology using the ISO/IEC 18000-7 standard for active RFID, operating at in the 433 MHz unlicensed spectrum. DASH7 provides multi-year battery life, range of up to 2 km (potentially farther), low latency for tracking moving objects, small protocol stack, sensor and security support, and data transfer of up to 200 kbit/s. DASH7 is the name of the technology promoted by the non-profit consortium called the DASH7 Alliance.

IEEE 802.11 is a set of standards carrying out wireless local area network (WLAN) computer communication in the 2.4, 3.6 and 5 GHz frequency bands. They are created and maintained by the IEEE LAN/MAN Standards Committee (IEEE 802). The base current version of the standard is IEEE 802.11-2007. IEEE802.11b and IEEE802.11g use the 2.4 GHz ISM band, operating in the United States under Part 15 of the US Federal Communications Commission Rules and Regulations;

IEEE 802.15.4-2006 is a standard which specifies the physical layer and media access control for low-rate wireless personal area networks (LR-WPANs). It is maintained by the IEEE 802.15 working group.

IEEE 802.15.1-2002 has derived a Wireless Personal Area Network standard based on the Bluetooth v1.1 specifications. It includes a media access control and physical layer specification. An updated version of this standard, based upon the additions incorporated into Bluetooth v1.2, was published as IEEE 802.15.1-2005; Following the publication of 802.15.1-2005, the IEEE Study Group 1b voted 90-0 to discontinue their relationship with the Bluetooth SIG, effectively meaning that the later versions of Bluetooth will not become future IEEE standards.

SO/IEC 18000 is an international standard that describes a series of diverse RFID technologies, each utilizing a unique frequency range. ISO/IEC 18000 consists of the following parts, under the general title Information technology—Radio frequency identification for item management: Part 6: Parameters for air interface communications at 860 MHz to 960 MHz; Part 7: Parameters for active air interface communications at 433 MHz;

The ISM (industrial, scientific and medical) radio bands were originally reserved internationally for the use of RF energy for industrial, scientific and medical purposes other than communications. In general, communications equipment operating in these bands must accept any interference generated by ISM equipment.

EPCglobal is a joint venture between GS1 (formerly known as EAN International) and GS1 US (formerly the Uniform Code Council, Inc.). It is an organization set up to achieve worldwide adoption and standardization of Electronic Product Code (EPC) technology. The main focus of the group currently is to create both a worldwide standard for RFID and the use of the Internet to share data via the EPCglobal Network;

Radio-frequency identification (RFID) is a technology that uses communication via radio waves to exchange data between a reader and an electronic tag attached to an object, for the purpose of identification and tracking. Some tags can be read from several meters away and beyond the line of sight of the reader. The application of bulk reading enables an almost parallel reading of tags.

Spectrum management is the process of regulating the use of radio frequencies to promote efficient use and gain a net social benefit. The term radio spectrum typically refers to the full frequency range from 3 kHz to 300 GHz that may be used for wireless communication. Increasing demand for services such as mobile telephones and many others has required changes in the philosophy of spectrum management.

A signal generator, also known variously as function generator, pitch generator, arbitrary waveform generator, digital pattern generator or frequency generator is an electronic device that generates repeating or non-repeating electronic signals (in either the analog or digital domains). They are generally used in designing, testing, troubleshooting, and repairing electronic or electro acoustic devices; though they often have artistic uses as well.

low power wireless networks is “green” technology and better use of power, a new generation low power wireless networks is use in machine to machine networks, Internet of things and for industrial and control applications, as well as for health, security and other purposes. That is truly wireless networks—without any network cables or power lines.

Wireless devices power-consumption analysis is to test low power wireless network devices, than analysis that the stringent battery-life requirements for sensor applications;

### SUMMARY OF THE INVENTION

the method of analyzing Internet of things on a low cost Real-time and synchronization Internet of things analyzer, the method comprising:
Providing a real time synchronization feature and high speed real time data capture and buffer;
Monitor, record and display data packages of wireless communications standards compliances to IEEE802.11.

802.15.4 or 802.15.1;
Simultaneously Store each wireless network node's all frequency spectrum, noise and interfere, network topology information.
Simultaneously monitor, record and analyze all wifi, zigbee, 6lowpan and Bluetooth, dash7, rf4ce, a variety of protocols packing and error status, electronic consumption, noise and noise waveform, high frequency interference signal, RFID communication commands and states.
Provide real time analysis and display graphics and curves in real time using multi-touch technology;

A System Architecture of Internet of things analyzer comprising:
high Speed control processing unit;
graphical display unit;
Wireless PAN/WLAN front end modules.
EPC RFID communication analysis front end modules,
ISM radio bands spectrum analysis front end modules,
ISM radio bands high frequency signals generators front end modules,
Low power analysis front end modules;
Wireless noise and interference analysis front end modules;
All the above modules and units are running at Real-time and synchronization conditions;

the method of measuring wireless network nodes and routers spectrum comprising:
Use a internet of things analyzer with the function of measuring spectrum as a Regular spectrum analyzer. But it is different than other Regular spectrum analyzer.
The internet of things analyzer which measures and displays the wireless network nodes and router's at ISM (industrial, scientific and medical) radio bands frequency spectrum and under all the following real-time conditions:
   1) Wireless network nodes or routers are running a communications protocol;
   2) Wireless network nodes or routers are measuring noise waveform, interfere,
   3) Wireless network nodes or routers are measuring low power consumption conditions;

the method of measuring wireless network nodes and routers low power consumption comprising:
Use a internet of things analyzer with the function of measuring voltage, current, and resistance as a Regular Multimeter, But it is different than other Regular Multimeter:
The internet of things analyzer which measures and displays the wireless network nodes and router's low power consumption under all the following real-time conditions:
   1) Wireless network nodes or routers are running a communications protocol;
   2) Wireless network nodes or routers are measuring noise waveform, interfere,
   3) Wireless network nodes or routers are measuring spectrum;

the method of measuring wireless network nodes and routers noise waveform, interfere comprising:
Use a internet of things analyzer with the function of measuring waveform as a Regular oscilloscope. But it is different than other Regular oscilloscope:
The internet of things analyzer which measures and displays the wireless network nodes and router's noise waveform, interfere under all the following real-time conditions:
1) Wireless network nodes or routers are running a communications protocol;
2) Wireless network nodes or routers are measuring low power consumption conditions,
3) Wireless network nodes or routers are measuring spectrum;

### BRIEF DESCRIPTION THE DRAWINGS

FIG. 1 is a block diagram of a Internet of things analyzer System Architecture;

FIG. 2 is a block diagram of a ISM radio bands high frequency signals generators front end modules of Internet of things analyzer;

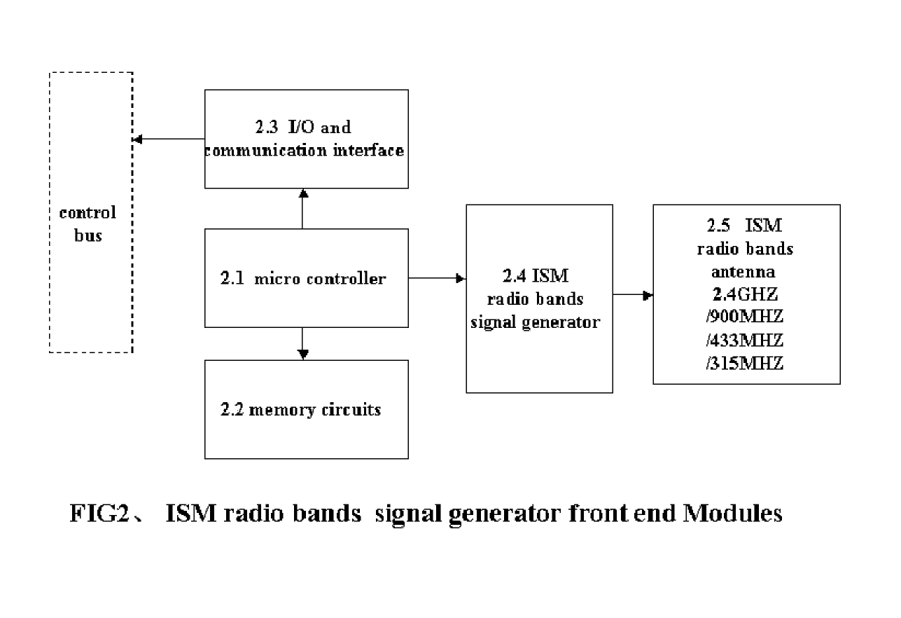

FIG. 3 is a block diagram of a Wireless PAN/WLAN front end module of Internet of things analyzer;

FIG. 4 is a block diagram of a ISM radio bands spectrum analysis front end modules of Internet of things analyzer;

FIG. 5 is a block diagram of a Low power analysis front end modules of Internet of things analyzer;

FIG. 6 is a block diagram of Wireless noise and interference analysis front end modules of Internet of things analyzer;

FIG. 7 is a block diagram of EPC RFID communication analysis front end modules of Internet of things analyzer;

### DETAILED DESCRIPTION OF THE PREFERRED EMBODIMENT

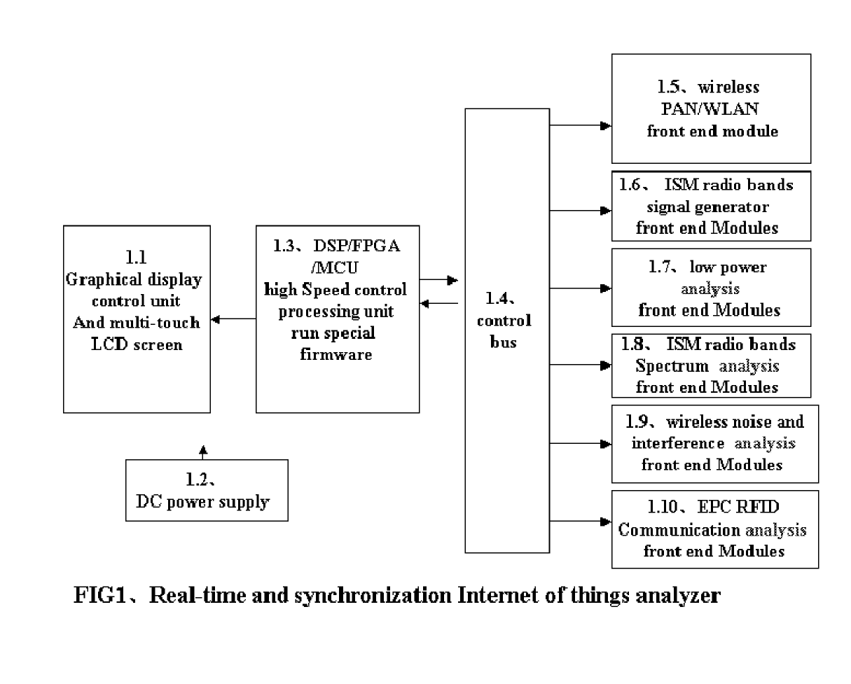

A Real-time and synchronization Internet of things analyzer System Architecture as FIG. 1;

System are composed of modules which wireless air data collection. Each front end module has a micro control or wireless system on chip (soc) unit; and memory circuits/I/O/communication interface. Using a control bus connects to high speed control processing unit (FIG. 1-1.3). The high speed control processing unit includes digit signal processing unit (DSP)/programming gate array (FPGA)/micro control unit (MCU).

high Speed control processing unit runs especial firmware to do data encryption, decodes, compression algorithm and more functions, then to send this information to display control unit (FIG. 1-1.1).

graphical display unit (FIG. 1-1.1), which provide real time analysis and display graphics and curves using multi-touch technology.

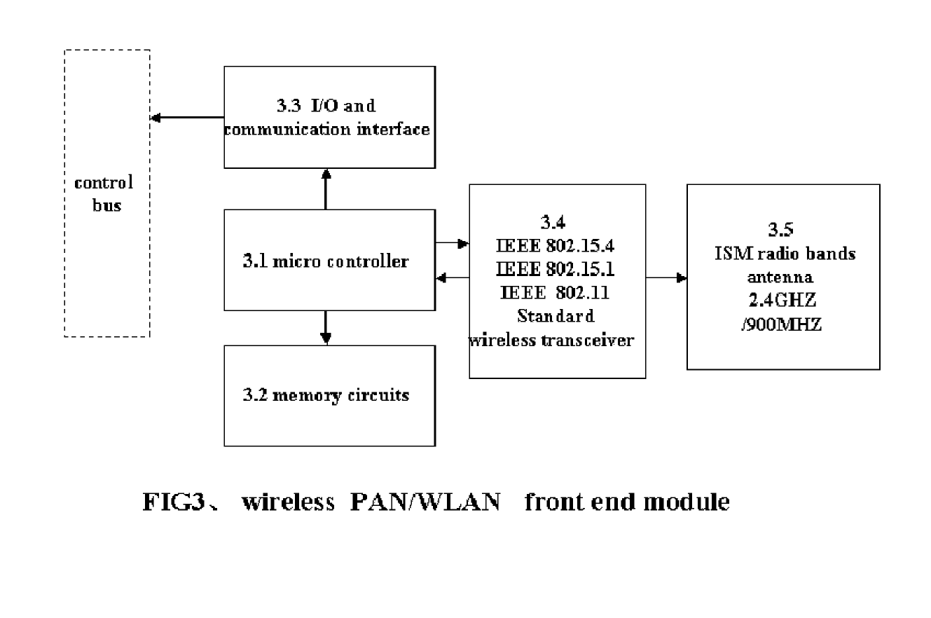

A wireless PAN/WLAN front end modules (FIG. 3) monitor a channel in the air using a high gain antenna (FIG. 3-3.5). Once these packages appear in the areas, the wireless transceiver (FIG. 3-3.4) will get the package information. These modules real time record these package information which be cached to memory (FIG. 3-3.2), then these information be sent to a data processing unit (FIG. 1-1.3) by a serial or parallel communication interface unit (FIG. 3-3.3);

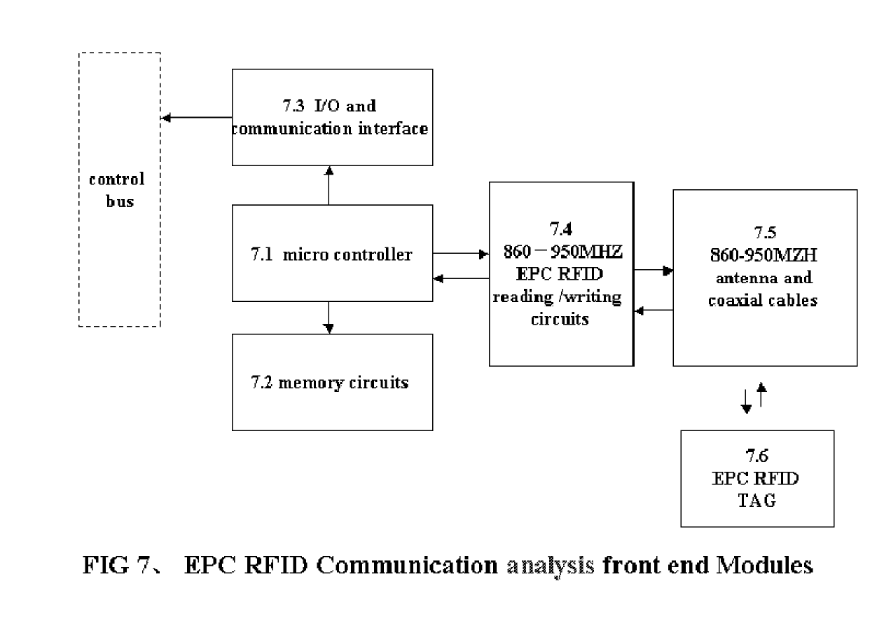

EPC RFID communication analysis front end modules (FIG. 7) which using a high gain antenna (FIG. 7-7.5) can measure and read/write to EPC RFID labels and tags (FIG. 7-7.6), monitor and analysis of EPC standard communications traffic. These modules real time record these EPC RFID communications information which be cached to memory (FIG. 7-7.2), then these information be sent to a data processing unit (FIG. 1-1.3) by a serial or parallel communication interface unit (FIG. 7-7.3).

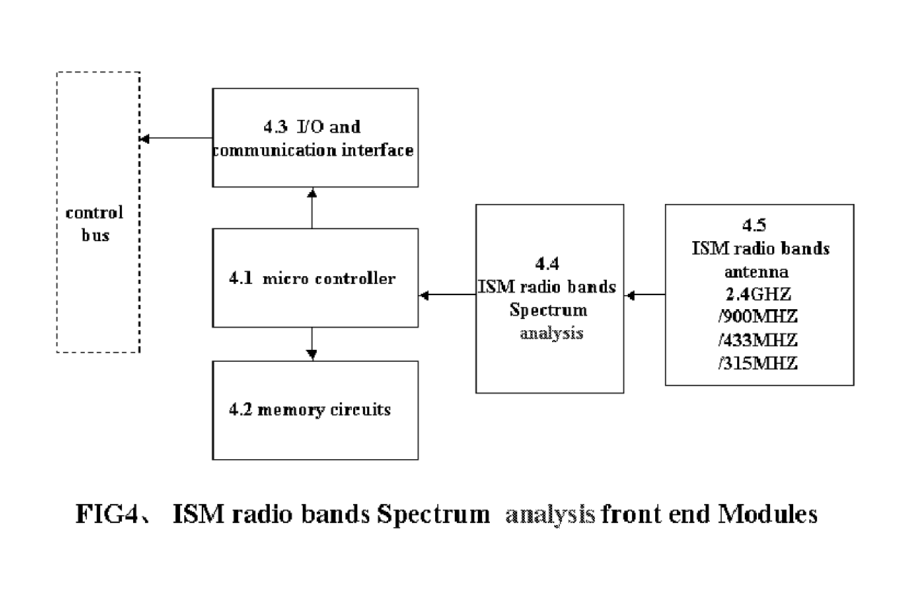

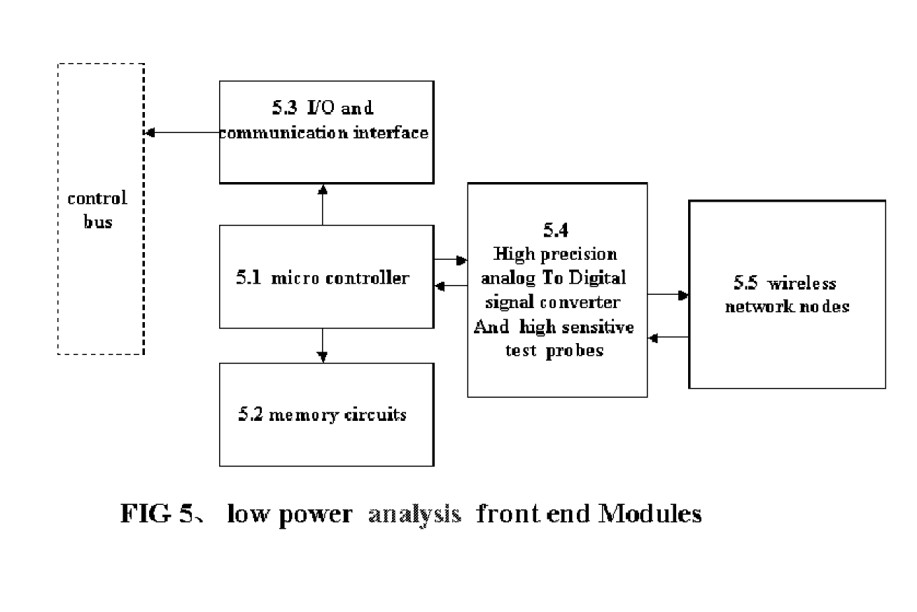

ISM radio bands spectrum analysis front end modules (FIG. 4) which using a high gain antenna (FIG. 4-4.5) real time collect and monitor these wireless nodes spectrum and record these spectrum information which be cached to memory (FIG. 5-4.2) then these information be sent to a data processing unit (FIG. 1-1.3) by a serial or parallel communication interface unit (FIG. 4-4.3);

Low power analysis front end modules (FIG. 5) use a high sensitive test probes and high precision analog signals to digital signal converter (A/D converter) (FIG. 5-5.4) to link wireless nodes (FIG. 5-5.5). These modules real time collect and monitor these wireless nodes power consumption and record these information which be cached to memory (FIG. 5-5.2), then these information be sent to a data processing unit (FIG. 1-1.3) by a serial or parallel communication interface unit (FIG. 5-5.3).

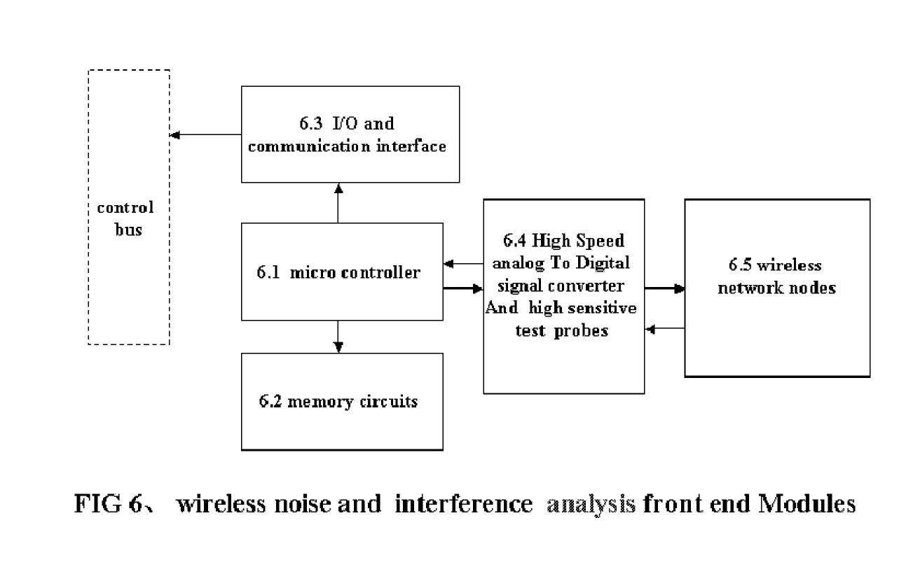

Wireless noise and interference analysis front end modules (FIG. 6) use a high speed test probes and high speed analog signals to digital signal converter (A/D converter) (FIG. 6-6.4) to link wireless nodes (FIG. 6-6.5), These modules real time collect and monitor these wireless nodes wireless noise and interference and record these information which be cached to memory (FIG. 5-6.2), then these information be sent to a data processing unit (FIG. 1-1.3) by a serial or parallel communication interface unit (FIG. 5-6.3);

What is claimed is:

1. A method of analyzing Internet of things on a low cost Real-time and synchronization Internet of things analyzer, the method comprising:
Provide a real time synchronization feature and high speed real time data capture and buffer;
Monitor record and display data packages of wireless communications standards compliances to IEEE802.11. 802.15.4 or 802.15.1;
Simultaneously Store each wireless network node's all frequency spectrum, noise and interfere, network topology information.
Simultaneously monitor, record and analyze all wifi, zigbee, 6lowpan and Bluetooth, dash7, rf4ce, a variety of protocols packing and error status, electronic consumption, noise and noise waveform, high frequency interference signal, RFID communication commands and states.
Provide real time analysis and display graphics and curves in real time using multi-touch technology;

2. A system architecture of Internet of things analyzer comprising:
high Speed control processing unit;
graphical display unit;
Wireless PAN/WLAN front end modules.
EPC RFID communication analysis front end modules,
ISM radio bands spectrum analysis front end modules,
ISM radio bands high frequency signals generators front end modules,
Low power analysis front end modules;
Wireless noise and interference analysis front end modules;
All the above modules and units are running at Real-time and synchronization conditions;

3. A method of measuring wireless network nodes and routers spectrum comprising:
Use a internet of things analyzer with the function of measuring spectrum as a Regular spectrum analyzer. But it is different than other Regular spectrum analyzer.
The internet of things analyzer which measures and displays the wireless network nodes and router's at ISM (industrial, scientific and medical) radio bands frequency spectrum. They are under all the following real-time conditions:
1) Wireless network nodes or routers are running a communications protocol;
2) Wireless network nodes or routers are measuring noise waveform, interfere,
3) Wireless network nodes or routers are measuring low power consumption conditions;

4. A method of measuring wireless network nodes and routers low power consumption comprising:
Use a internet of things analyzer with the function of measuring voltage, current, and resistance as a Regular Multimeter, But it is different than other Regular Multimeter:
The internet of things analyzer which measures and displays the wireless network nodes and router's low power consumption under all the following real-time conditions:
1) Wireless network nodes or routers are running a communications protocol;
2) Wireless network nodes or routers are measuring noise waveform, interfere,
3) Wireless network nodes or routers are measuring spectrum;

5. A method of measuring wireless network nodes and routers noise waveform, interfere comprising:
Use a internet of things analyzer with the function of measuring waveform as a Regular oscilloscope. But it is different than other Regular oscilloscope:
The internet of things analyzer which measures and displays the wireless network nodes and router's noise waveform, interfere under all the following real-time conditions:
1) Wireless network nodes or routers are running a communications protocol;
2) Wireless network nodes or routers are measuring low power consumption conditions,
3) Wireless network nodes or routers are measuring spectrum;
